(19) United States
(12) Patent Application Publication
(10) Pub. No.: US 2002/0040084 A1
(43) Pub. Date: Apr. 4, 2002

(54) Fly ash filler and polyvinyl chloride compositions and conduits therefrom

(75) Inventors: Joel A. Colmar, Scottsdale, AZ (US); Aron R. McBay, Gilbert, AZ (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Boral Material Technologies, Inc.

(21) Appl. No.: 09/769,650

(22) Filed: Jan. 25, 2001

Related U.S. Application Data
(63) Continuation of application No. 09/329,853, filed on Jun. 11, 1999, now abandoned.
(60) Provisional application No. 60/088,896, filed on Jun. 11, 1998.

(51) Int. Cl. C08K 3/18

(52) U.S. Cl. 524/430; 524/493; 524/494; 106/638

(57) ABSTRACT

A composition comprising fly ash particles with an average particle diameter of not greater than 100 micrometers and a moisture content of not greater than 0.25 percent by weight. The compositions are useful as both a filler and a colorant in polymer containing compositions, particularly polyvinyl chloride compositions for extruding pipes and conduits. Desirably, the composition is used at a filler loading level of from about 1 to about 80 parts by weight of the fly ash per hundred parts of the polymer. Fly ash-filled polyvinyl chloride compositions containing the fly ash as described meet commercial requirements and are economically and environmentally beneficial.

### FIELD OF THE INVENTION

The present invention is directed to particulate coal fly ash compositions that are useful as fillers and, optionally, colorants in polymer-based compositions. In one desirable embodiment, the present invention is directed to fly ash compositions that are useful as fillers in polyvinyl chloride based compositions and fly ash filled polyvinyl chloride compositions therefrom. These fly ash-filled polyvinyl chloride compositions are useful for manufacturing pipes, conduits and other profiles of various shapes and sizes, particularly electrical conduits.

### BACKGROUND OF THE INVENTION

Fillers are frequently added to plastic compositions to reduce the costs of and to improve the properties of products produced from the plastic compositions. Fillers are usually inorganic, inert materials that can be added to plastic resins and can reduce cost, reduce shrinkage, improve surface appearance and improve moldability. Fillers typically cost much less than the plastic resins into which they are incorporated and therefore, increasing the amount of filler that can be admixed into the resin generally decreases the overall material cost. Although fillers are used in combination with resins primarily to reduce cost, they may also improve ultraviolet resistance, heat deflection temperature, electrical properties, blocking resistance, and control opacity and gloss. Pigments are used in resins to provide color and may increase opacity and weathering characteristics.

Fillers are typically admixed into a molten plastic material prior to or during forming of an article of the filled plastic material. The admixing of the filler can be done by a plastic resin supplier, a special compounder whose expertise is the selection and addition of various additives or by a manufacturer of the plastic article. Extrusion is one common method of incorporating fillers into plastic compositions.

The interaction of a filler surface with a polymer is a highly complex physiochemical phenomenon. In order to maximize performance, the individual filler particles must be deaglomerated, dispersed uniformly throughout the polymer matrix and wetted by the polymer. Methods of improving the interaction of the filler surface with the polymer include treating the surface of the filler particles with stearates, resinates, silanes, etc. These surface treatments add to the cost of fillers.

Polyvinyl chloride (hereinafter “PVC”) resins are readily available, low cost plastic resins that are used to form pipes, conduits and other assorted profiles. The PVC compositions that are used to form these articles typically contain some type of filler to increase the stiffness and the thermal stability to articles manufactured from the filled PVC compositions. Calcium carbonate, CaCO₃, is a common filler incorporated in PVC compositions. Other types of fillers are primarily limited to specialty applications, e.g., calcined clays for electrical applications. Calcium carbonate is, predominantly, a mined material that requires crushing and grinding of mined limestone to be used as a filler material. Mining and subsequent crushing and grinding of calcium carbonate add to the cost of the calcium carbonate as filler. Further, because calcium carbonate is mined from naturally occurring deposits, calcium carbonate has limited regional availability and may require extensive shipping. Shipping also adds to the cost of calcium carbonate as a filler.

In contrast, fly ash is a byproduct that is produced by coal burning facilities, such as power generating plants, and is more readily available. Fly ash consists of fine particles of essentially non-combustible material that is a byproduct of the combustion of coal. Particles of fly ash are removed from the combustion gasses produced by coal burning facilities to reduce the discharge of solid particulates into the atmosphere. Fly ashes may contain aluminosilicates, mullite, hematite or magnetite, for example. Because fly ash is produced in abundance, it is readily available at lesser cost than most fillers. Although fly ash is currently incorporated into concrete and brick compositions, there is a need to develop additional uses for fly ash.

The use of fly ash as a filler offers various advantages over the use of various other mineral fillers. Fly ash is more readily available and has lower cost than other widely used mineral fillers. Fly ash also has a lower specific gravity. For example, the specific gravity of fly as is about 2.1-2.4 compared to calcium carbonate, which has a specific gravity of about 2.7. Thus, fly ash and fly ash-filled compositions are lighter in weight and may be substituted for conventional fillers to reduce shipping costs. Further, the intrinsic color of the fly ash varies from gray to black and may be used to reduce the amount of black colorant required in the filled plastic compositions such as electrical conduits.

Fly ash has been employed as a filler in synthetic polymer compositions, for examples U.S. Pat. Nos. 3,991,005 and 4,268,320. These patents teach the use of fly ash fillers of only small particle sizes and use only a small portion of the fly ash produced by coal burning facilities. The fly ash employed required extensive processing prior to incorporation in the synthetic polymer compositions.

Air classification is one method of size processing fly ash particles. Air classification separates particles based on the principle that particle drag force and particle mass force are a function of particle size. In general, air classification only recovers a fraction of the viable fly ash particles of a particular size. The fraction of fly ash particles recovered depends on the desired particle size separation. Air classification is inefficient and yields only a portion of the fly ash particles of the desired size. The remaining, unwanted fraction is usually sent to waste, thereby increasing landfill burden.

What is needed is a fly ash composition that can be used as a filler in various polymers, uses a larger portion of the fly ash produced by coal burning facilities, does not require extensive processing, and produces a fly ash-filled polymer compositions that meet commercial standards.

### SUMMARY OF THE INVENTION

The present invention also includes polymer compositions that contains fly ash particles with a particle diameter of not greater than about 100 micrometers and a moisture content of not greater than about 0.25 percent by weight dispersed therein. The polymer compositions can contain from about 1 to 80 parts by weight fly ash per hundred by weight resin. Fly ash filler loading levels for PVC of about 5 to 40 parts per hundred of fly ash are desired and filler loading levels of about 10 to 20 parts per hundred are more desired. The polymer compositions describe herein comprise polyvinyl chloride as the base resin. Fly ash-filled polyvinyl chloride compositions containing the fly ash particles as described herein can be provided to extrude conduits that meet commercial and industry standards. Desirably, the fly ash-filled polyvinyl chloride conduits described herein meet industry standards.

The present invention attempts to maximize the use of fly ash, thereby eliminating or decreasing the amount of fly ash that must be disposed. The present invention may also be used to eliminate and/or decrease colorants and processing steps and costs. Although, air classification may be utilized in the present invention as a technique to remove some of the coarser fly ash particles and impurities that can create surface roughness or physical property inadequacies in the filled resin, air classification is not required to the degree and extent previously considered.

Accordingly, it is an object of the present invention to provide a use for a larger proportion of the fly ash produced by coal burning facilities.

An additional object of the present invention is to reduce fly ash waste and pollution.

An additional object of the present invention is to provide novel fly ash compositions and fly ash-filled composites therefrom which require less size processing.

An additional object of the present invention is to provide a filler composition that does not require any surface treatment in order to be used successfully as a filler for plastic compositions.

An additional object of the present invention is to provide pipes and conduits that meet industry standards.

These and other objects of the invention will become apparent to persons skilled in the art in view of the description below.

### DETAILED DESCRIPTION

The present invention is a fly ash composition that can be used as a filler and a colorant in polymer containing compositions. The present invention also includes fly ash-filled polymer containing compositions, particularly fly ash-filled PVC compositions. The fly ash and fly ash-filled polymer compositions of the present invention use a larger proportion of the fly ash produced by coal burning facilities, and are thus more economically efficient and environmentally beneficial than prior art fly ash compositions and fly ash-filled compositions. The fly ash compositions and fly ash-filled compositions of the present invention contain particles of a broader and larger range of sizes, having an effective top size of about 100 micrometers, and thus requires less size separation and processing, resulting in less waste and energy consumption. The fly ash-filled polymer compositions can contain from about 1 to 80 parts per hundred by weight of fly ash particles. For, PVC-based compositions used to extrude conduits, fly ash filler loading levels of about 5 to 40 parts per hundred of fly ash are desired and filler loading levels of about 10 to 20 parts per hundred are more desired.

The fly ash of the present invention can be either processed or unprocessed. Processing includes, but is not limited to, air classification, screening, and gravity separation. Composites comprising PVC and the particulate filler, the coal fly ash, may be designed to meet American Society of Testing and Materials (ASTM) and Underwriters Laboratory, Inc. (UL) industry specifications and standards, particularly the specifications and standards for conduits. The physical properties of the PVC composites are dictated by the quantity and quality of fly ash in the PVC as defined by the parameters described below and may be adjusted to meet desired values, specifications and standards. Additionally, various additives may be used to achieve desired properties of the composition to accommodate fly ashes that have a wide range of physical and chemical properties. Thus, fly ashes with various particle size distributions, sizes, chemistries, and impurities can be used successfully in PVC pipe depending on the desired PVC composite properties.

The fly ash of the present invention desirably has a top particle size of up to about 100 micrometers. The “top size” of a particle as used herein is defined as the largest particle measured on a Coulter Laser Diffraction LS100 Particle Analyzer. The “effective top size” is the particle diameter corresponding to about less than 99.5 percentile as measured on a Coulter Laser Diffraction LS 100 Particle Analyzer. Most unprocessed fly ashes contain between from about 10 to 25 percent by weight particles not less than 44 micrometers and about 50 percent by volume particles not greater than 6 to 16 micrometers with a top size of about 100 micrometers.

Although most fly ash compositions contain no particles with a top size of greater than 100 micrometers, not all fly ash compositions will meet UL and ASTM standards for conduits. There is an inverse relationship between filler loading level of a fly ash composition and the size distribution or top size of a fly ash composition. At higher loading levels, PVC compositions require lower top sizes to meet either the UL standard or ASTM specification. For example, the fly ash filled PVC conduit of Comparative Sample B illustrates that a PVC composite containing 40 parts per hundred parts resin (phr) of a fly ash filler containing particles of a top size of greater than 100 micrometers does not meet UL specifications.

Particle size and distribution of the fly ash filler can be varied depending on the desired end use and properties of the filled PVC composition. Particle size is inversely proportional to impact strength. Therefore, if additional impact strength is desired, particle size may be decreased. As stated above, the appropriate size and distribution of the filler is dictated by the end use of the PVC composite. For example, a PVC composite with 40 parts per hundred of an unprocessed fly ash containing particles of sizes greater than 100 micrometers, as shown in Example 2, successfully passes only 1 of 5 impacts of 72 foot-pounds (ft-lbs) at 32° F. Whereas, an air-classified fly ash with a top particle size of about 88 micrometers at the same loading level, as shown in Example 2, successfully passes 5 of 5 impacts of 72 ft-lbs at 32° F.

Loading levels of the fly ash in PVC may vary from about 1 to 80 parts by weight fly ash per one hundred parts by weight PVC. Loading level is defined as the ratio of the weight of the filler or additive to the weight of the base resin and can be expressed in parts of additive per hundred parts base resin which is abbreviated as phr. A desired fly ash filler level is about 5 to 40 parts by weight fly ash per one hundred parts by weight PVC. A more desired fly ash filler level is about 10 to 20 parts by weight fly ash per one hundred parts by weight PVC. Higher filler loading levels are desired to reduce costs but lower filler levels may be needed in order to maintain certain mechanical properties.

Additionally, the fly ash should have a moisture content of not greater than about 0.25 percent by weight. Excess moisture in the fly ash causes separation of the ash spheres from the resin matrix, thereby lowering impact strength. If the moisture is not properly vented during the extrusion process, the excess moisture can cause voids in the extrudate adversely affecting impact strength and stiffness.

In one embodiment, the fly ash is incorporated as a filler in PVC compositions used to produce pipes, conduits and profiles. Various PVC resins of varying molecular weights, distributions etc. may be used depending on the desired properties. Generally, higher molecular weight PVC resins are used for extrusion. Any of a variety of commercially available PVC resins may be used depending on the desired final properties and processing conditions. Desirably, the PVC resin is a general-purpose PVC pipe resin. Additionally, various additives may be included in or added to the PVC resin.

Due to the thermal sensitivity of PVC, the PVC can contain stabilizers to facilitate processing of the PVC. The PVC compositions may optionally contain lubricants to reduce the affinity of the PVC for the metal surfaces of the extruder. Further additives that may be incorporated into the composition include impact modifiers, colorants/whitening agents, UV stabilizers, fire retardants, coupling agents, and/or any other conventionally used processing aids and additives. Typical additives and additive levels for PVC include from approximately 0.3 to 1.0 phr heat stabilizers, from 0.8 to 4.0 phr lubricants, from approximately 0.1 to 1.0 phr colorants, and from approximately 0 to 80.0 phr fillers or extenders. Typical additives and additive levels for extruding pipes and conduits include from approximately 0.4 to 0.5 phr heat stabilizers, from 2.0 to 3.5 phr lubricants, 1.0 phr colorants, and from 3 to 50 phr fillers or extenders. Filler loading levels at the higher end of these ranges are used for pipes and conduits used in non-pressure and higher tensile modulus applications.

Partial replacement of fly ash with conventional fillers may be required to achieve the desired physical properties. Varying extrusion-processing parameters is yet another tool allowing for variation in fly ash properties while still producing PVC profiles with the desired end physical properties. For example, temperatures in the extruder may require adjustment to obtain the desired wall smoothness. Other processing variables include, but are not limited to, die temperature, extruder screw rpm, mass flow rate of extrudate (output), etc.

Because fly ash typically costs less than calcium carbonate, fly ash can be used more economically than calcium carbonate. Further, because the fly ash compositions taught herein require less size classification and, thus, less processing, the fly ash compositions and fly ash-filled PVC compositions of the present invention can be used more economically. The fly ash compositions and fly ash-filled PVC compositions of this invention allow use of a greater portion of the fly ash generated by coal burning facilities, without a significant loss in properties of products formed from the filled compositions. Advantageously, the present invention may be used to decrease waste fly ash and should result in decreased disposal of fly ash and accumulation in landfills.

The invention has been demonstrated in the following examples by extruding conduits from PVC compositions containing from about 5 to 40 phr of a Class F fly ash filler as described and also include conventional amounts of stabilizers, lubricants and optionally colorants. Class F fly ash was selected based on availability, but it is believed that the amount of lime in Class C fly ashes may cause premature degradation of the conduits produced from PVC compositions containing large amounts of Class C fly ash. It is also suggested to select fly ash compositions with low Loss on Ignition (LOI) because incorporation of higher LOI fly ashes may produce mechanically inferior conduits and may interfere with coloring pigments.

The fly ash filler of Examples 1-10 consisted essentially of particles of an effective top size of less than 100 micrometers and may require some size classification. However, the fly ash compositions and fly ash-filled compositions of the present invention use a larger portion of the fly ash as received from coal burning facilities. Comparative Sample A was extruded from a PVC composition containing stearate-treated calcium carbonate, Comparative Samples C-E were extruded from PVC compositions containing untreated calcium carbonate and Comparative Sample B was extruded from a PVC composition containing fly ash filler greater than 100 micrometers in size.

### COMPARATIVE SAMPLE A

Comparative Sample A is intended as a control example to demonstrate the properties of a conventional PVC conduit that meets ASTM standard F512-93. The conduit of Comparative Sample A was produced at a large PVC pipe processing plant and was extruded from a PVC composite containing 40 phr of a calcium carbonate filler. The calcium carbonate filler used in Comparative Sample A was obtained from crushed limestone had a median particle size of 2 micrometers and was calcium stearate treated. Calcium stearate treatment of calcium carbonate particles is used to improve the interaction of the calcium carbonate particles with the PVC, facilitating higher loading levels. Pretreatment of filler adds to the cost to the filler, as do crushing and other processing steps.

This calcium carbonate filled PVC composite was extruded with a single screw extruder, model no. KM110 obtainable from Krauss-Mafai of Munich, Germany. A conduit was produced. The conduit was a four inch nominal DB (Direct Burial) 100 PVC conduit that meets ASTM standard F512-93.

### COMPARATIVE SAMPLE B

Comparative Sample B was also produced at the same pipe processing plant under essentially the same processing conditions as Comparative Sample A. However, Comparative Sample B was extruded from PVC filled with 40 phr of a fly ash composition having particles with sizes greater than 100 micrometers, instead of the 2 micrometer median calcium carbonate composition used in Comparative Sample A. The fly ash composition used in Comparative Sample B was a light gray-tan fly ash with the following size distribution:

### Particle Size Distribution of the Fly Ash Filler of Comparative Sample B

| Volume Percentage | Size of Particles |
|---|---|
| of Particles | (micrometers) |
| 97 | <704 |
| 61 | <44 |
| 53 | <31 |
| 45 | <22 |
| 33 | <11 |
| 12.5 | <2 |

Note, the fly ash of Comparative Sample B contained particles with sizes of greater than 100 micrometers. About 3 volume percent of the fly ash composition had a size greater than 704 micrometers. It is believed that the existence of particles having sizes greater than 704 micrometers was caused by contamination of the fly ash composition of Comparative Sample B.

A four inch nominal DB 100 PVC conduit was extruded from the PVC filled with the fly ash of Comparative Sample B. The conduit of Comparative Sample B had insufficient stiffness and only passed 1 of 5 impacts of 72 foot-pounds at 32° F. Further, the conduit of Comparative Sample B had 30 percent lower stiffness than the conduit of Comparative Sample A filled with the limestone. The conduit of Comparative Sample B does not meet UL 1285 for electrical conduits.

### EXAMPLE 1

PVC conduit in this Example 1 was produced at the same PVC processing plant under essentially the same conditions as Comparative Samples A and B, but was extruded from PVC containing 30 phr 2 micrometer average particle size, calcium stearate-treated calcium carbonate and 10 phr fly ash with an top size of about 88 micrometers and an effective top size of 44 micrometers. The fly ash composition of Example 1 was a light gray-tan fly ash of the same source as Comparative Sample B but was air classified to the following particle size distribution:

### Particle Size Distribution of the Fly Ash Filler of Examples 1 and 2

| Volume Percentage | Size of Particles |
|---|---|
| of Particles | (micrometers) |
| 100 | <88 |
| 99.5 | <44 |
| 98.5 | <31 |
| 95 | <22 |
| 81 | <11 |
| 30 | <2 |

The fly ash of Example 1 contained essentially no particles with sizes of greater than 88 micrometers. The calcium carbonate and fly ash-filled four inch nominal DB 100 PVC conduit of Example 1 had a stiffness equal to the limestone control of Comparative Sample A and passed 5 of 5 impacts of 72 ft-lbs at 32° F. The fly ash-filled PVC of Example 1 meets UL. specification 1285 with respect to flattening and impact tests for electrical conduit and contains fly ash particles of a diameter greater than 25 micrometers. The fly ash filler of Example 1 requires less air classification than the filler compositions taught by the prior art and uses a larger proportion of the fly ash produced by coal burning facilities. The lesser classified fly ash filler of Example 1 is easier and cheaper to obtain and uses a greater portion of fly ash generated by coal burning facilities than previously thought possible. Such use of the fly ash filler results in a decrease in disposal of waste fly ash and a decrease in associated environmental problems.

### EXAMPLE 2

The PVC conduit of Example 2 was produced at the same PVC pipe processing plant under essentially the same conditions as Example 1 and Comparative Samples A and B, but was instead extruded from PVC containing 40 phr of the fly ash of Example 1 and no calcium carbonate. The fly ash composition of Example 2 was the same light gray-tan fly ash of the source of Comparative Sample B and Example 1 and was air classified to the particle size distribution of Example 1.

Again, the fly ash of Example 2 had an effective top size of 100 micrometers and contained essentially no particles with sizes of greater than 88 micrometers. The PVC used to extrude the conduit of Example 2 contained a higher concentration of fly ash, than Example 1, 40 phr compared to 10 phr. The conduit of Example 2 incorporated only fly ash as filler and did not contain any calcium carbonate as did Example 1. The four inch nominal DB 100 PVC conduit of Example 2 has stiffness comparable to that of the limestone control of Comparative Sample A and passed 5 of 5 impacts of 72 ft-lbs at 32° F. The fly ash-filled PVC conduit of Example 2 meets UL 1285 specification with respect to flattening and impact tests for electrical conduit. Because Example 2 uses a larger proportion of filler, conduit produced from compositions similar to that of Example 2 require less material costs and result in even less fly ash waste, and result in a larger decrease in disposal and associated environmental problems.

### COMPARATIVE SAMPLES C-H

Comparative Samples C-H were produced at a medium-size PVC pipe processing plant producing two inch SDR 21 CL 200 conduits with a minimum wall thickness of 0.113 inches. The conduits were formed on a KD 11 conical twin screw extruder. KD 11 conical twin screw extruders can be obtained from Cincinnati Milacron of Cincinnati, Ohio. The fillers of Comparative Samples were mixed in to the PVC at about 210° F. to 225° F. using a paddle mixer. The paddle mixers used were Littleford paddle mixers and can be obtained from Littleford Day Company of Florence, Ky. Hot mixing was accomplished at 210° F. and the filler was added during the last two minutes of the hot batch cycle.

Comparative Samples C, D and E were extruded from filled PVC compositions containing about 20, 30 and 40 phr of a 4 micrometer median untreated calcium carbonate filler, respectively. Comparative Samples F, G and H were extruded from filled PVC compositions containing 20, 30 and 40 phr of a light gray coal fly ash, respectively. The light gray fly ash used in Comparative Samples F, G, and H had the following particle size distribution:

### Particle Size Distribution of the Fly Ash Filler of Comparative Samples F, G and H

| Volume Percentage | Size of Particles |
|---|---|
| of Particles | (micrometers) |
| 100 | <110 |
| 99.96 | <95 |
| 75 | <22.5 |
| 50 | <7 |
| 30 | <3 |
| 22 | <2 |
| 9 | <1 |

The following test results were obtained for conduits extruded from the PVC compositions of Comparative Samples C-H:

| Comparative | Filler and Loading | Impact Height | flattening |
|---|---|---|---|
| Sample No. | Level (phr) | (inches) | (% pass) |
| C | CaCO₃ at 20 | 108 | 100 |
| D | CaCO₃ at 30 | 84 | 100 |
| E | CaCO₃ at 40 | 78 | 100 |
| F | Fly Ash at 20 | 9 | 0 |
| G | Fly Ash at 30 | 8 | 0 |
| H | Fly Ash at 40 | 3.5 | 0 |

In the above table, impact height refers to the height in inches at which a five pound dart dropped on a pipe section resulted in 9 out of 10 pipe sections remaining intact after the impact of the dart. Flattening refers to the percentage of pipe sections that did not crack when compressed to such a degree that the two opposite sides of the pipe touched each other.

The conduits extruded from the PVC compositions comprising the fly as compositions of Comparative Samples F, G and H containing fly ash of an effective top size larger than 100 micrometers do not meet the performance of the control examples, Comparative Samples C-E. Notably, the appearance of the fly ash-filled conduits was darker than the conduits extruded from the PVC compositions containing calcium carbonate and were somewhat mottled and pitted.

### EXAMPLES 3-10

Examples 3, 4 and 5 were prepared using three different filler loading levels, 20, 30 and 40 phr respectively, of a first air-classified light gray coal fly ash, referred to herein as Fly Ash #1. Examples 6, 7, 8, 9 and 10 were prepared using 5, 10, 20, 30 and 40 phr, respectively, of a second air-classified, finer light gray coal fly ash, referred to herein as Fly Ash #2. The two fly ashes, Fly Ash #1 and Fly Ash #2, had effective top sizes of less then 100 micrometers and had the following particle size distributions:

### Particle Size Distribution of Fly Ash #1 of Examples 3, 4 and 5

| Volume Percentage | Size of Particles |
|---|---|
| of Particles | (micrometers) |
| 100 | <95 |
| 99.37 | <65 |
| 75 | <14 |
| 60 | <8 |
| 50 | <6 |
| 30 | <2.5 |
| 9 | <1 |

### Particle Size Distribution of Fly Ash #2 of Examples 6, 7, 8, 9 and 10

| Volume Percentage | Size of Particles |
|---|---|
| of Particles | (micrometers) |
| 100 | <95 |
| 99.27 | <65 |
| 86 | <14 |
| 74 | <8 |
| 67 | <6 |
| 50 | <3 |
| 14 | <1 |

The conduits extruded from the PVC compositions of Examples 3-10 and Comparative Samples C-E were tested and the results of the tests are presented below:

| Example/ | Filler and Loading | Impact Height | Flattening |
|---|---|---|---|
| Example No. | Level (phr) | (inches) | (% pass) |
| C | CaCO₃ at 20 | 108 | 100 |
| D | CaCO₃ at 30 | 84 | 100 |
| E | CaCO₃ at 40 | 78 | 100 |
| 3 | Fly Ash #1 at 20 | 9 | — |
| 4 | Fly Ash #1 at 30 | 7 | — |
| 5 | Fly Ash #1 at 40 | 13 | — |
| 6 | Fly Ash #2 at 5 | 146 | — |
| 7 | Fly Ash #2 at 10 | 123 | — |
| 8 | Fly Ash #2 at 20 | 48 | — |
| 9 | Fly Ash #2 at 30 | 26 | — |
| 10 | Fly Ash #2 at 40 | 22 | — |

The fly ash-filled PVC compositions of Examples 3-10 contained essentially no particles of a size greater than 95 micrometers. Conduits extruded from filled PVC compositions containing less filler, both for fly ash filler and calcium carbonate filler, had greater impact strength. Conduits extruded from fly ash-filled PVC compositions containing fly ash filler at low filler levels, from about 1 to about 15 phr, have sufficient impact strength for most commercial uses, including meeting the performance standards of the control samples, Comparative Samples A and C-E.

The present invention has been illustrated in great detail by the above specific Examples. It is to be understood that these Examples are illustrative embodiments and that this invention is not to be limited by any of the Examples or details in the Description. Those skilled in the art will recognize that the present invention is capable of many modifications and variations without departing from the scope of the invention. Accordingly, the Detailed Description and Examples are meant to be illustrative and are not meant to limit in any manner the scope of the invention as set forth in the following claims. Rather, the claims appended hereto are to be construed broadly within the scope and spirit of the invention.

What is claimed is:

1. A polyvinyl chloride composition comprising polyvinyl chloride and fly ash particles, wherein the fly ash particles have a diameter greater than about 25 micrometers and are characterized by a moisture content of not greater than about 0.25 percent by weight water and an average particle size of not greater than about 100 micrometers.

2. The polyvinyl chloride composition of claim 1, wherein the fly ash particles have an effective top size of about 100 micrometers.

3. The polyvinyl chloride composition of claim 2, wherein the fly ash particles have an effective top size of about 95 micrometers.

4. The polyvinyl chloride composition of claim 3, wherein the fly ash particles have an effective top size of about 88 micrometers.

5. The polyvinyl chloride composition of claim 1, wherein the fly ash particles comprise at least about 0.5 volume percent fly ash particles with a diameter of not less than 44 micrometers.

6. The polyvinyl chloride composition of claim 1, wherein the fly ash particles comprise at least about 1.5 volume percent fly ash particles with a diameter of not less than 31 micrometers.

7. The polyvinyl chloride composition of claim 1, wherein the fly ash particles comprise at least about 5 volume percent fly ash particles with a diameter of not less than 25 micrometers.

8. The polyvinyl chloride composition of claim 1, wherein the fly ash particles comprise at least about 25 volume percent fly ash particles with a diameter of not less than 22.5 micrometers.

9. The polyvinyl chloride composition of claim 1, wherein the polyvinyl chloride composition comprises from about 1 to 80 parts by weight of the fly ash per hundred parts by weight of the polyvinyl chloride.

10. The polyvinyl chloride composition of claim 9, wherein the polyvinyl chloride composition comprises from about 5 to 40 parts by weight of the fly ash per hundred parts by weight of the polyvinyl chloride.

11. The polyvinyl chloride composition of claim 10, wherein the polyvinyl chloride composition comprises from about 10 to 20 parts by weight of the fly ash per hundred parts by weight of the polyvinyl chloride.

12. A pipe comprising the polyvinyl chloride composition of claim 1 and meeting ASTM standard F512-93.

13. A conduit comprising the polyvinyl chloride composition of claim 1 and meeting UL specification 1285 for flattening and impact.

12. A polyvinyl chloride composition comprising polyvinyl chloride and fly ash particles, wherein the fly ash particles have diameters greater than 25 micrometers, an effective top size of about 100 micrometers and a moisture content of not greater than about 0.25.

13. A composition comprising fly ash consisting essentially of fly ash particles with an average particle diameter of not greater than 100 micrometers and a moisture content of not greater than 0.25 percent by weight yet comprise some fly ash particles with diameters greater than 25 micrometers.

14. The composition of claim 13, wherein the fly ash particles have an effective top size of about 100 micrometers.

15. The composition of claim 14, wherein the fly ash particles have an effective top size of about 95 micrometers.

16. The composition of claim 15, wherein the fly ash particles have an effective top size of about 88 micrometers.

17. The composition of claim 13, wherein the fly ash particles comprise at least about 0.5 volume percent fly ash particles with a diameter of not less than 44 micrometers.

18. The composition of claim 13, wherein the fly ash particles comprise at least about 1.5 volume percent fly ash particles with a diameter of not less than 31 micrometers.

19. The composition of claim 13, wherein the fly ash particles comprise at least about 5 volume percent fly ash particles with a diameter of not less than 25 micrometers.

20. The composition of claim 13, wherein the fly ash particles comprise at least about 25 volume percent fly ash particles with a diameter of not less than 22.5 micrometers.
